(19) United States
(12) Patent Application Publication
(10) Pub. No.: US 2016/0349758 A1
(43) Pub. Date: Dec. 1, 2016

(54) LOGISTICS SYSTEM AND LOGISTICS METHOD

(71) Applicant: HON HAI PRECISION INDUSTRY CO., LTD., New Taipei (TW)

(72) Inventors: CHANG-SHENG WANG, New Taipei (TW); MI-CHIEN CHEN, New Taipei (TW)

(21) Appl. No.: 15/076,890

(22) Filed: Mar. 22, 2016

(30) Foreign Application Priority Data
May 29, 2015 (TW) 104117562

(51) Int. Cl. G05D 1/02

(52) U.S. Cl. CPC G05D 1/0274; G05D 1/0276; G05D 2201/0216

(57) ABSTRACT

A logistics system applies to a logistic vehicle and a plurality of production equipment is provided. The logistic system includes a position confirming module, a calculating module, and a driving control module. The position confirming module is configured to determine a current position of the logistic vehicle based on strengths of the first signals and a relationship recording relationships between first signal strengths and distances between the logistic vehicle and the production equipment. The calculating module is configured to calculate a first optimal path for the logistic vehicle from the current position to the production equipment which transmitted a second signal indicating finished machining based on a map including the plurality of the production equipment and the current position of the logistic vehicle. The driving control module is configured to control the logistic vehicle to move according to the first optimal path. A logistics method is also provided.

### FIELD

The subject matter herein generally relates to a logistics system and a logistics method.

### BACKGROUND

In industry production, logistic vehicles, such as automatic guided vehicles are used to transport workpieces from one production equipment to another production equipment, supply the workpieces to a plurality of production equipment, or remove the workpieces from the production equipment.

### BRIEF DESCRIPTION OF THE DRAWINGS

Implementations of the present technology will now be described, by way of example only, with reference to the attached figures.

FIG. 1 is a block diagram of a first embodiment of a logistics system.

FIG. 2 is a block diagram of production equipment and a logistic vehicle of the first embodiment of the logistics system.

FIG. 3 is a block diagram of a server of the first embodiment of the logistics system.

FIGS. 4 and 5 cooperatively constitute a flowchart of a logistics method using the logistics system shown in FIG. 1.

FIG. 6 is a block diagram of a second embodiment of a logistics system.

FIG. 7 is a block diagram of production equipment and a logistic vehicle of the second embodiment.

FIG. 8 is a block diagram of a server of the second embodiment.

FIGS. 9 and 10 cooperatively constitute a flowchart of a logistics method using the logistics system shown in FIG. 6.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented. The term “comprising” when utilized, means “including, but not necessarily limited to”; it specifically indicates open-ended inclusion or membership in the so-described combination, group, series and the like.

The present disclosure is described in relation to a logistics system and a logistics method.

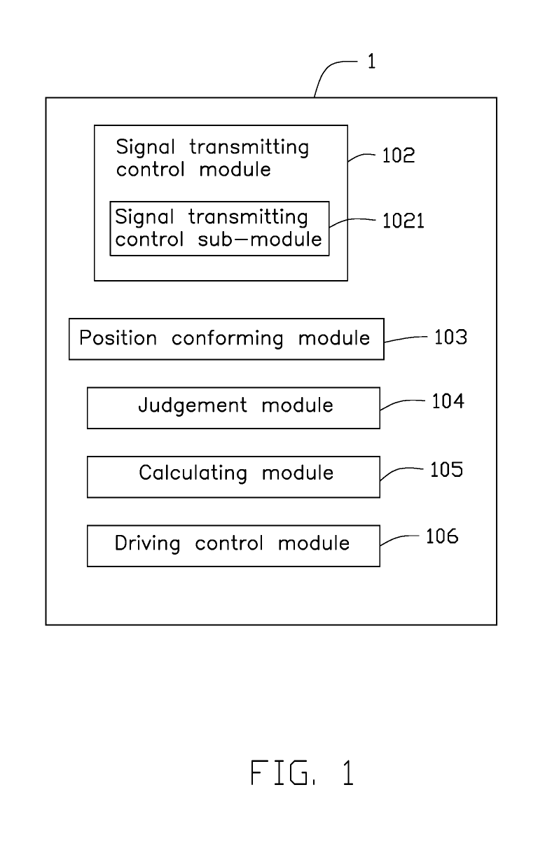

FIG. 1 illustrates that a logistics system 1 of a first embodiment includes a signal transmitting control module 102, a position confirming module 103, a judgment module 104, a calculating module 105, and a driving control module 106. The signal transmitting control module 102 can include a plurality of signal transmitting control sub-modules 1021.

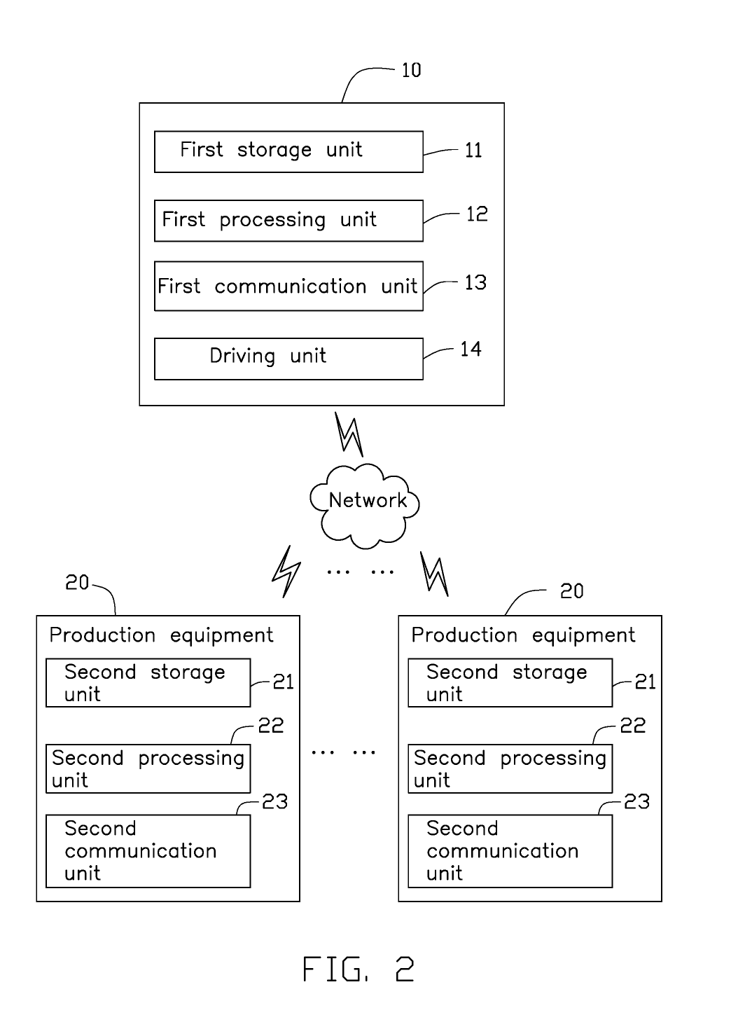

FIG. 2 illustrates a logistic vehicle 10 and a plurality of production equipment 20. In the first embodiment, the production equipment 20 belong to different work sections to process a workpiece successively, that is the plurality of production equipment 20 can cooperatively process one workpiece. The logistics system 1 can apply to the logistic vehicle 10 and the production equipment 20.

The logistic vehicle 10 can include a first storage unit 11, a first processing unit 12, a first communication unit 13, and a driving unit 14. Each production equipment 20 can include a second storage unit 21, a second processing unit 22, and a second communication unit 23. The first communication unit 13 can receive a first signal and a second signal transmitted by the second communication unit 23. The first signal can be a signal assist to determine the position of the logistic vehicle 10, and the second signal can be an indicator signal for indicating the production equipment 20 has finished machining. In at least one embodiment, each of the first signals transmitted by the production equipment 20 has a specific internet protocol address. The first signal can be, but not limited to, a WIFI signal.

The first storage unit 11 can store a relationship recording relationships between the strengths of the first signals and the distances between the logistic vehicle and the production equipment 20 which transmit the first signal. The first storage unit 11 can further storage a process flow of the production equipment 20 and the production equipment 20 corresponding to each work section. The first storage unit 11 can further storage a final position of the workpiece need to be placed after finally processed. The driving unit 14 can be configured to drive the logistic vehicle 10.

The first communication unit 13 can be further configured to receive a third signal of a map including the production equipment 20. The map can be a relationship recording the production equipment 20 and the coordinates of the production equipment 20.

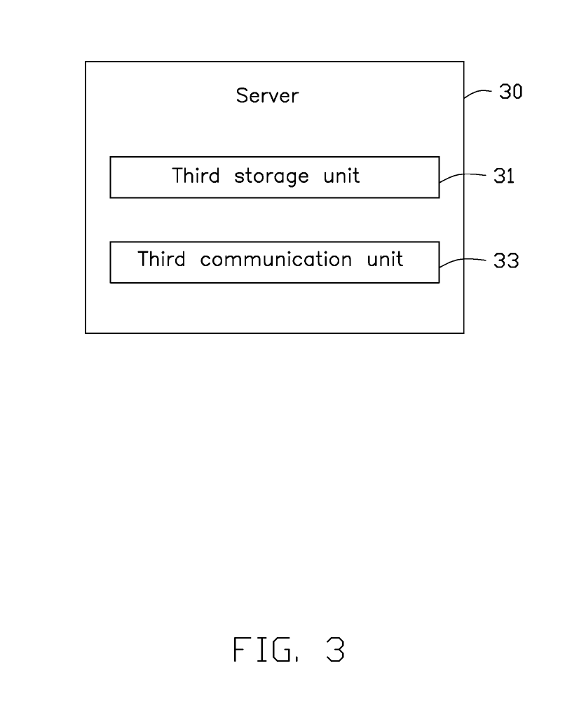

FIG. 3 illustrates that a server 30 can include a third storage unit 31 and a third communication unit 33. The map of the production equipment 20 can be stored in the third storage unit 31 of the server 30. The map can be calculated manually. If any production equipment 20 is moved and the position is changed, the map can be refreshed by manual and stored in the third storage unit 31. The third communication unit 33 can transmit the third signal of the map, the first communication unit 13 can receive the third signal, and the first storage unit 11 can store the map.

The signal transmitting control sub-module 1021 can be a series of computer program instruction period stored in the second storage unit 21 of the production equipment 20 and executed by the second processing unit 22. The position confirming module 103, the judgment module 104, the calculating module 105, and the driving control module 16 can be a series of computer program instruction period stored in the first storage unit 11 of the logistic vehicle 10 and executed by the first processing unit 12. In other embodiments, the modules in the logistics system 1 can be hardware blocks in the first processing unit 12 and the second processing unit 22. For example, the first storage unit 11 and the second storage unit 21 can be hard disks, floppy diskettes, USB disks, or random access memories. The first processing unit 12 and the second processing unit 22 can be central processing blocks (CPUs), digital signal processors (DSPs), or microcontrollers.

After the first communication unit 13 received the first signals transmitted from the second communication units 23 of the production equipment 20, the position confirming module 103 can determine a position relation between the logistic vehicle 10 and the processing equipment 20 based on the strengths of the first signals and the relationship stored in the first storage unit 11. Thus the position of the logistic vehicle 10 in the map can be determined.

Each signal transmitting control sub-module 1021 can be configured to control the second communication unit 23 to transmit the second signal after the corresponding production equipment 20 finished machining.

After the first communication unit 13 received the second signal, the calculating module 105 can calculate an optimal path for the logistic vehicle 10 from the current position to the production equipment 20 which transmitted the second signal. The optimal path can be calculated based on the genetic algorithm.

The driving control module 106 can control the driving unit 14 according to the optimal path; thus, the logistic vehicle 20 can move to the production equipment 50 which transmitted the second signal driven by the driving unit 14.

After the logistic vehicle 10 got the workpiece, the position confirming module 103 can determine the current position of the logistic vehicle 10 in the map. Then, the judgment module 104 can read the next working section and determine whether the next working section is the last one.

If the judgment module 104 determines that the next working section is not the last one, the calculating module 105 can calculate an optimal path for the logistic vehicle 10 from the current position to the production equipment 20 of the next working section. The optimal path can be calculated based on the current position of the logistic vehicle 10 and the map of the production equipment 20 stored in the first storage unit 11. The driving control module 106 can control the driving unit 14 according to the optimal path, and the logistic vehicle 104 can move to the next production equipment 20 driven by the driving unit 14.

If the judgment module 104 determines that the next working section is the last one, the calculating module 105 can calculate an optimal path for the logistic vehicle 10 from the current position to the final position of the workpiece. The optimal path can be calculated based on the current position of the logistic vehicle 10 and the final position of the workpiece stored in the first storage unit 11. The driving control module 106 can control the driving unit 14 according to the optimal path, and the logistic vehicle 104 can move to the final position driven by the driving unit 14.

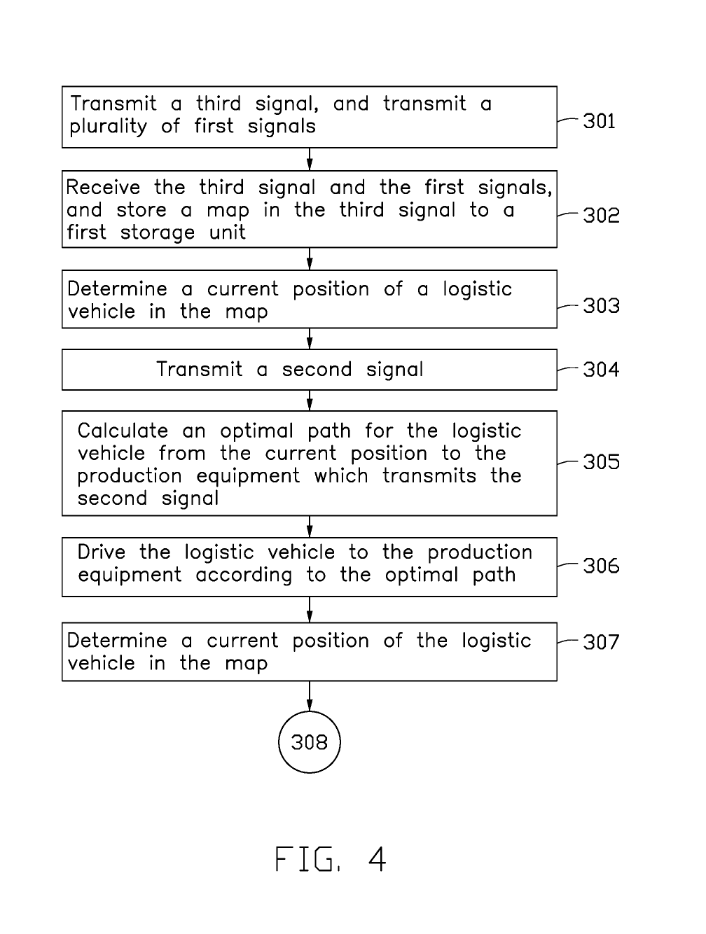

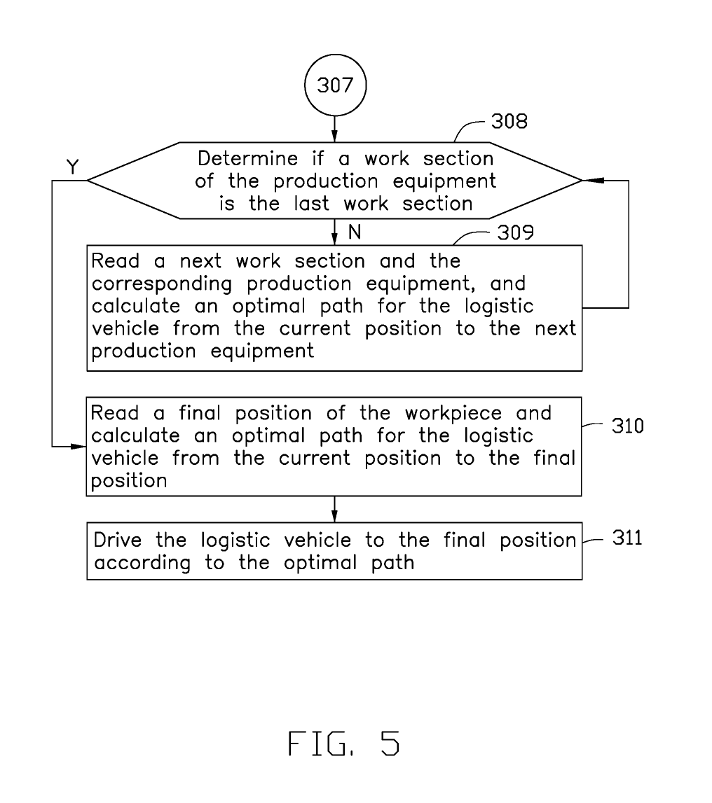

Referring to FIG. 4 and FIG. 5, a flowchart is presented in accordance with an example embodiment which is being thus illustrated. The example method is provided by way of example, as there are a variety of ways to carry out the method. The method described below can be carried out using the configurations illustrated in FIG. 1 through FIG. 3, for example, and various elements of these figures are referenced in explaining example method. Each block shown in FIG. 4 and FIG. 5 represents one or more processes, methods or subroutines, carried out in the example method. Additionally, the illustrated order of blocks is by example only and the order of the blocks can change according to the present disclosure. The example method can begin at block 301.

At block 301, a third communication unit of a server transmits a third signal including a map, and second communication units of a multiple production equipment transmit a plurality of first signals in real time.

At block 302, a first communication unit receives the third signal and the first signals, and stores the map in the third signal to a first storage unit.

At block 303, a position confirming module determines a current position of a logistic vehicle based on the strengths of the first signals and the relationship recording the relationships between the first signal strengths and the distances from the production equipment transmitted the first signal. The position confirming module determines the current position of the logistic vehicle in the map.

At block 304, a signal transmitting control sub-module of a production equipment controls a second communication unit of the production equipment, thus the second communication unit transmits the second signal which indicated that the production equipment has finished machining.

At block 305, a calculating module responses to the second signal and calculates an optimal path for the logistic vehicle from the current position to the production equipment which transmitted the second signal.

At block 306, a driving control module controls a driving unit according to the optimal path, and the logistic vehicle moves to the production equipment driven by the driving unit which transmitted the second signal.

At block 307, the position confirming module determines an current position of the logistic vehicle in the map after the logistic vehicle got the workpiece.

At block 308, a judgment module determines if the production equipment is the equipment of the last working section. If so, the process can proceed to the block 310. If not, the process can proceed to the block 309.

At block 309, the calculating module reads a next working section stored in the first storage unit and the corresponding production equipment, and calculates an optimal path for the logistic vehicle from the current position to the production equipment of the next working section.

At block 310, the calculating module read a final position of the workpiece from the first storage unit and calculates an optimal path of the logistic vehicle from the current position to the final position.

At block 311, the driving unit is controlled by the driving control module, and the logistic vehicle moves to the final position of the workpiece.

The logistics system 1 can determine the position relation between the logistic vehicle 10 and the production equipment 20 based on the relationship recording the relationships between the strengths of the first signal and the distances to the production equipment 20 which transmit the first signal, thus the current position of the logistic vehicle 10 in the map can be determined. After the logistic vehicle 10 received the second signal transmitted by the production equipment 20, the logistics system 1 can calculate the optimal path for the logistic vehicle 10 from the current position to the production equipment 20 which transmitted the second signal. Then, the driving unit 14 can drive the logistic vehicle 10 to the production equipment 20 which transmitted the second signal. There is no need to wait for a predetermined time to move to the next production equipment 20. Therefore, the logistics system 1 can save waiting time of the logistic vehicle 10.

In other embodiments, the first storage unit 11 can store the optimal paths from each production equipment 20 to the next production equipment 20, and the optimal path from the last production equipment 20 to the final position of the workpiece. Accordingly, the processes in the block 309 and 310 can be omitted. At block 311, the driving control module 106 can read the optimal path from the first storage unit 11, and the driving unit 41 can be controlled by the driving control module 106 and drive the logistic vehicle 10 to the final position.

In other embodiments, the map of the multiple production equipment 20 can be stored in the first storage unit 11, and the server 30 can be omitted. At block 301, the process of transmitting the third signal can be omitted.

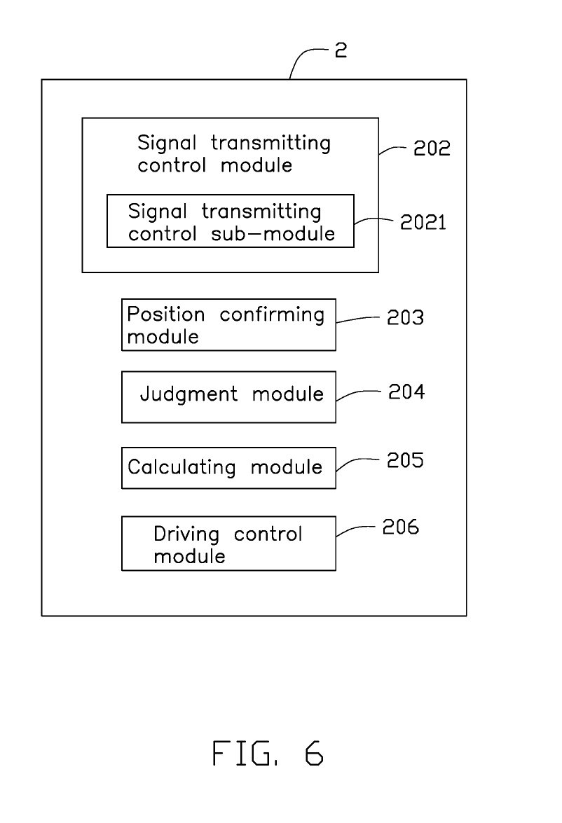

FIG. 6 illustrates a logistics system 2 of a second embodiment of this disclosure. The logistics system 2 includes a signal transmitting control module 202, a position confirming module 203, a judgment module 204, a calculating module 205, and a driving control module 206. The signal transmitting control module 202 can include a plurality of signal transmitting control sub-modules 2021.

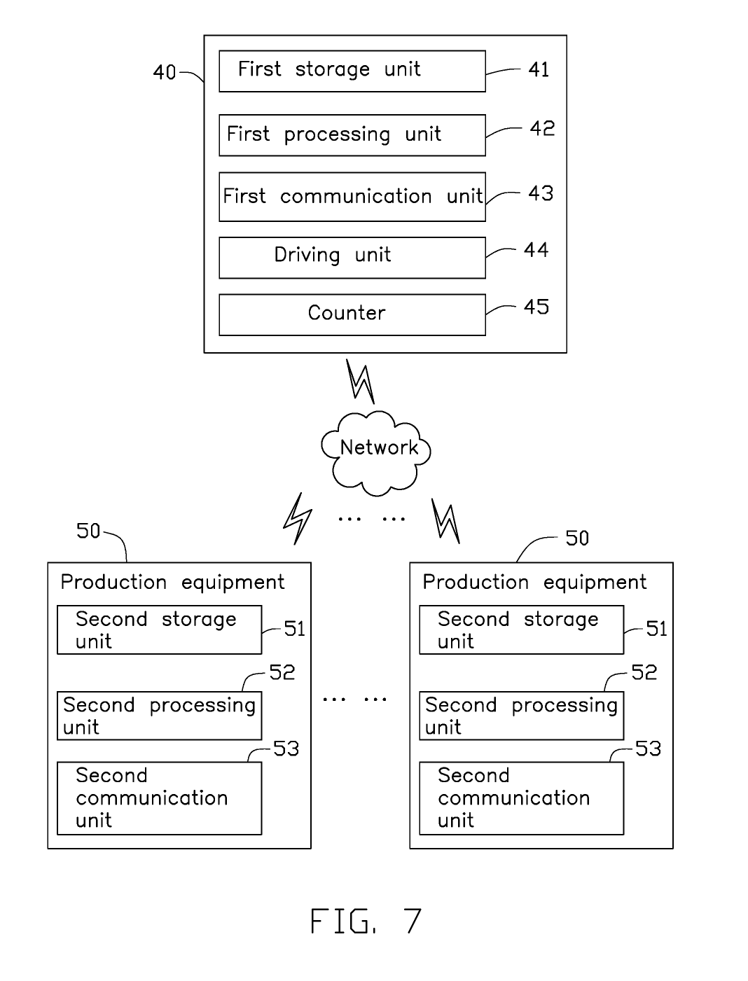

FIG. 7 illustrates a logistic vehicle 40 and a plurality of production equipment 50. Each production equipment 50 can be configured to process workpieces at one same work section. The logistic vehicle 10 can move to the production equipment 50 which finished machining the workpiece to get the workpiece, and move to a final position of the workpieces after a number of the workpieces carried by the logistic vehicle 40 achieved to a predetermined value.

The logistic vehicle 40 can include a first storage unit 41, a first processing unit 42, a first communication unit 43, and a driving unit 44. Each production equipment 50 can include a second storage unit 51, a second processing unit 52, and a second communication unit 53. The first communication unit 43 can receive a first signal and a second signal transmitted by the second communication unit 53. The first signal can be a signal assist to determine the position of the logistic vehicle 10, and the second signal can be an indicator signal for indicating the production equipment 50 has finished machining. In at least one embodiment, each of the first signals transmitted by the production equipment 50 has a specific internet protocol address. The first signal can be, but not limited to, a WIFI signal.

The first storage unit 41 can store a relationship recording the relationships between the strength of the first signals and the distances between the logistic vehicle 40 to the production equipment 50 which transmit the first signals. The first storage unit 41 can further store a process flow of the production equipment 50 and the production equipment 50 corresponding to each work section. The first storage unit 41 can further store a final position of the workpiece need to be placed after finally processed. The driving unit 44 can be configured to drive the logistic vehicle 10. The logistic vehicle 40 can further include a counter 45, and the first storage unit 41 can store a default value of the maximum number of the workpieces can be carried by the logistic vehicle 40.

The first communication unit 43 can be further configured to receive a third signal of a map including the production equipment 50. The map can be a relationship between the production equipment 50 and the coordinates of the production equipment 50.

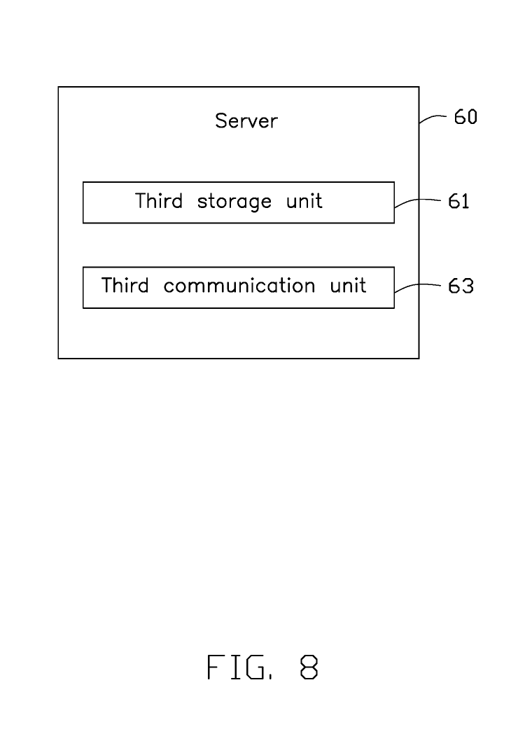

FIG. 8 illustrates that a server 60 can include a third storage unit 61 and a third communication unit 63. The map of the production equipment 50 can be stored in the third storage unit 61 of the server 60. The map can be calculated manually. If any production equipment 50 is moved and the location is changed, the map can be refreshed by manual and stored in the third storage unit 61. The third communication unit 63 can transmit the third signal of the map, the first communication unit 43 can receive the third signal, and the first storage unit 41 can store the map.

The signal transmitting control sub-module 2021 can be a series of computer program instruction period stored in the second storage unit 51 of the production equipment 50 and executed by the second processing unit 52. The position confirming module 503, the judgment module 504, the calculating module 505, and the driving control module 506 can be a series of computer program instruction period stored in the first storage unit 41 of the logistic vehicle 40 and executed by the first processing unit 42. In other embodiments, the modules in the logistics system 2 can be hardware blocks in the first processing unit 42 and the second processing unit 52.

After the first communication unit 43 received the first signals transmitted from the multiple second communication units 53 of the production equipment 50, the position confirming module 203 can determine a position relation between the logistic vehicle 40 and the corresponding processing equipment 50 based on the strengths of the first signals and the relationship stored in the first storage unit 41. Thus the position of the logistic vehicle 40 in the map can be determined.

Each signal transmitting control module 2021 can be configured to control the second communication unit 53 to transmit the second signal after the corresponding production equipment 50 finished machining.

After the first communication unit 43 received the second signal, the calculating module 205 can calculate an optimal path for the logistic vehicle 40 from the current position to the production equipment 50 which transmitted the second signal. The optimal path can be calculated based on the genetic algorithm.

The driving control module 206 can control the driving unit 44 according to the optimal path, thus the logistic vehicle 40 can move to the production equipment 50 which transmitted the second signal driven by the driving unit 44.

After the logistic vehicle 40 got the workpiece, the position confirming module 303 can determine the current position of the logistic vehicle 40 in the map. Then, the judgment module 204 can determine if a number recorded in the counter 45 is smaller than the default value.

If the judgment module 104 determines that the number recorded in the counter 45 is not smaller than the default value, the calculating module 205 can calculate an optimal path for the logistic vehicle 40 from the current position of the logistic vehicle 40 to the final position of the workpieces. At this time, the number in the counter 45 can be equal to the default value. The optimal path can be calculated based on the current position of the logistic vehicle 40 and the map of the production equipment 50 stored in the first storage unit 41. The driving control module 206 can control the driving unit 44 according to the optimal path, and the logistic vehicle 40 can move to the final position driven by the driving unit 44.

If the judgment module 104 determines that the number recorded in the counter 45 is smaller than the default value, the first communicating module 43 can wait the second signal. The calculating module 205 can calculate an optimal path for the logistic vehicle 40 from the current position to the production equipment 50 which transmitted the second signal. The optimal path can be calculated based on the current position of the logistic vehicle 40 and map of the production equipment 50 stored in the first storage unit 41. The driving control module 206 can control the driving unit 44 according to the optimal path, and the logistic vehicle 40 driven by the driving unit 14 and move to the production equipment 50 which transmitted the second signal.

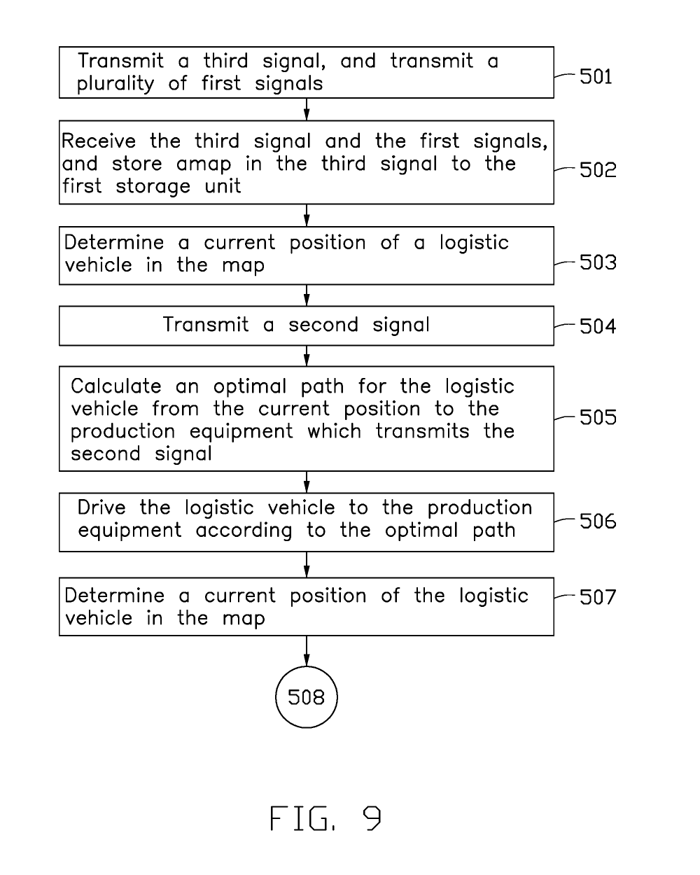

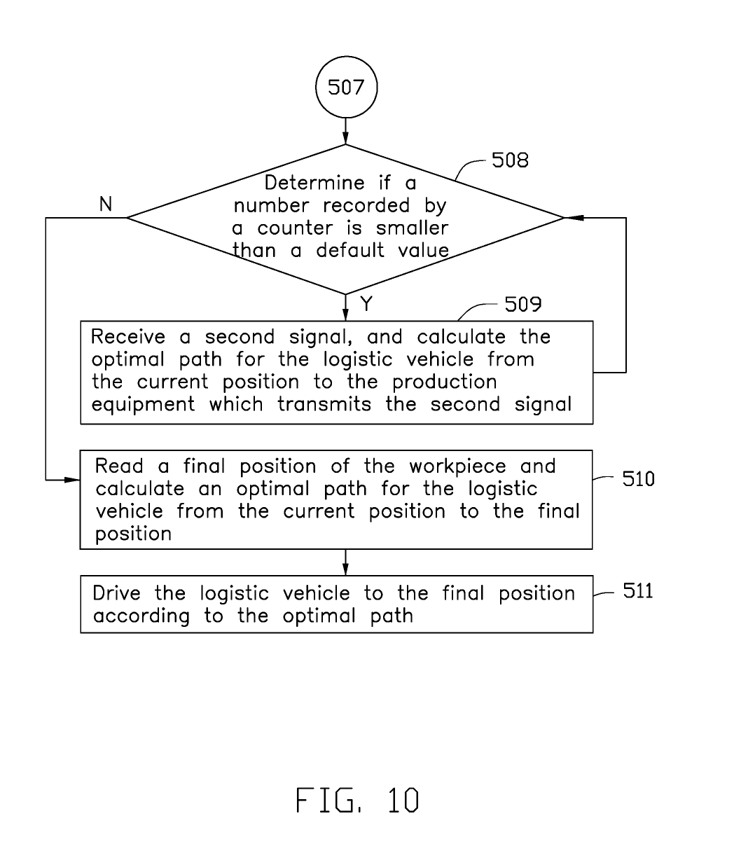

Referring to FIG. 9 and FIG. 10, a flowchart is presented in accordance with an example embodiment which is being thus illustrated. The example method is provided by way of example, as there are a variety of ways to carry out the method. The method described below can be carried out using the configurations illustrated in FIG. 6 through FIG. 8, for example, and various elements of these figures are referenced in explaining example method 200. Each block shown in FIG. 9 and FIG. 10 represents one or more processes, methods or subroutines, carried out in the example method. Additionally, the illustrated order of blocks is by example only and the order of the blocks can change according to the present disclosure. The example method can begin at block 501.

At block 501, a third communication unit of a server transmits a third signal including a map, and a plurality of second communication units of the multiple production equipment transmits the first signals in real time.

At block 502, a first communication unit receives the third signal and the first signals, and stores the map in the third signal to a first storage unit.

At block 503, a position confirming module determines an current position of the logistic vehicle based on the strengths of the first signals and the relationship between each first signal strength and the distance from the production equipment transmitted the first signal. The position confirming module determines the current position of the logistic vehicle in the map.

At block 504, the signal transmitting control sub-module of the production equipment controls the second communication unit of the production equipment, thus the second communication unit transmits the second signal of finished machining.

At block 505, a calculating module responses the second signal and calculates an optimal path for the logistic vehicle from the current position to the production equipment which transmitted the second signal.

At block 506, a driving control module controls a driving unit according to the optimal path, and the logistic vehicle is driven by the driving unit and moves to the production equipment, which transmitted the second signal.

At block 507, the position confirming module determines an current position of the logistic vehicle in the map after the logistic vehicle got the workpiece.

At block 508, a judgment module determines if a number of a counter is smaller than a default value. If so, the process can proceed to the block 510. If not, the process can proceed to the block 509.

At block 509, after the first communication unit received the second signal, the calculating module calculates an optimal path of the logistic vehicle from the current position to the production equipment which transmitted the second signal.

At block 510, the calculating module reads a final position of the workpiece from the first storage unit and calculates an optimal path of the logistic vehicle from the current position to the final position.

At block 511, the driving unit is controlled by the driving control module, and the logistic vehicle moves to the final position of the workpieces driven by the driving unit.

The logistics system 2 can determine the position relation between the logistic vehicle 40 and the production equipment 50 based on the relationship multiple first signal strengths and correspondence between each signal strength and the corresponding distance from the logistic vehicle 40 to the production equipment 50, thus the current position of the logistic vehicle 40 in the map can be determined. After the logistic vehicle 40 received the second signal transmitted by the production equipment 50, the logistics system 2 can calculate the optimal path for the logistic vehicle 40 from the current position to the production equipment 50 which transmitted the second signal. Then, logistic vehicle 10 can move to the production equipment 20 which transmitted the second signal. There is no need to wait for a predetermined time to move to the next production equipment 50. Therefore, the logistics system 2 can save waiting time of the logistic vehicle 40.

In other embodiments, the first storage unit 41 can store the optimal paths from each production equipment 50 to the next production equipment 50, and the optimal path from the last production equipment 50 to the final position of the workpiece. Accordingly, the processes in the block 509 and 510 can be omitted. At block 511, the driving control module 206 can read the optimal path from the first storage unit 41, and the driving unit 41 can be controlled by the driving control module 206 and drive the logistic vehicle 40 to the final position.

In other embodiments, the map of the multiple production equipment 50 can be stored in the first storage unit 41, and the server 60 can be omitted. At block 501, the process of transmitting the third signal can be omitted.

The embodiments shown and described above are only examples. Many details are often found in the art such as the other features of a logistics system and a logistics method. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. A logistics system applies to a logistic vehicle and a plurality of production equipment, the logistics system comprising:
a position confirming module configured to determine a current position of the logistic vehicle after a first communication unit of the logistic vehicle receives first signals transmitted by the plurality of the production equipment, the determination is based on strengths of the first signals and a relationship recording relationships between the strengths of the first signals and distances between the logistic vehicle and the production equipment, wherein the relationship being stored in a first storage unit of the logistic vehicle;
a calculating module configured to calculate a first optimal path for the logistic vehicle from the current position to one, which transmitted a second signal indicating finished machining after the logistic vehicle received the second signal of the production equipment, the calculation is based on a map comprising the plurality of the production equipment and the current position of the logistic vehicle; and
a driving control module configured to control the logistic vehicle to move to the production equipment, which transmitted the second signal according to the first optimal path.

2. The logistics system as claimed in claim 1, wherein the logistics system further comprises a signal transmitting control module configured to control second communication units of the plurality of the production equipment to transmit the second signal.

3. The logistics system as claimed in claim 1, wherein the logistics system further comprises a judgment module configured to determine whether a working section corresponding to the production equipment which transmitted the second signal is a last working section based on a process flow and corresponding production equipment stored in the first storage unit of the logistic vehicle.

4. The logistics system as claimed in claim 3, wherein the judgment module further configured to read a next working section from the first storage unit when the working section corresponding to the production equipment is not the last working section, and calculate a second optimal path for the logistic vehicle from the current position to the production equipment corresponding to the next working section.

5. The logistics system as claimed in claim 3, wherein the calculating module is further configured to calculate a third optimal path for the logistic vehicle from the current position to a final position of workpieces when the working section corresponding to the production equipment is the last working section.

6. The logistics system as claimed in claim 1, wherein the logistics system further comprises a judgment module configured to determine if a number recorded by a counter on the logistic vehicle is smaller than a default value, and the default value is the maximum number of workpieces carried by the logistic vehicle.

7. The logistics system as claimed in claim 6, wherein the calculating module is further configured to calculate a fourth optimal path for the logistic vehicle from the current position to a final position of workpieces when the number recorded by the counter is equal to the default value.

8. The logistics system as claimed in claim 6, wherein the calculating module is further configured to calculate a fifth optimal path for the logistic vehicle from the current position to the next production equipment which transmitted the second signal when the number recorded by the counter is smaller than the default value.

9. A logistics method applies to a logistic vehicle and a plurality of production equipment, the method comprising:
determining a current position of the logistic vehicle after a first communication unit of the logistic vehicle received first signals transmitted by the plurality of the production equipment, based on strengths of the first signals and a relationship recording relationships between the strengths of the first signals and distances between the logistic vehicle and the production equipment, the relationship being stored in a first storage unit of the logistic vehicle;
calculating a first optimal path for the logistic vehicle from the current position to the production equipment which transmitted a second signal indicating finished machining after the logistic vehicle received the second signal, based on a map comprising the plurality of the production equipment and the current position of the logistic vehicle; and
controlling the logistic vehicle to move to the production equipment which transmitted the second signal according to the first optimal path.

10. The logistics method as claimed in claim 9, wherein the method further comprises:
determining whether a working section corresponding to the production equipment which transmitted the second signal is a last working section based on a process flow and corresponding production equipment stored in the first storage unit of the logistic vehicle.

11. The logistics method as claimed in claim 9, wherein the method further comprises:
reading a next working section from the first storage unit when the working section corresponding to the production equipment is not the last working section, and calculating a second optimal path for the logistic vehicle from the current position to the production equipment corresponding to the next working section.

12. The logistics method as claimed in claim 9, wherein the method further comprises:
calculating a third optimal path for the logistic vehicle from the current position to a final position of workpieces when the working section corresponding to the production equipment is the last working section.

13. The logistics method as claimed in claim 9, wherein the method further comprises:
determining if a number recorded by a counter on the logistic vehicle is smaller than a default value, the default value being the maximum number of workpieces carried by the logistic vehicle.

14. The logistics method as claimed in claim 13, wherein the method further comprises:
calculating a fourth optimal path for the logistic vehicle from the current position to a final position of workpieces when the number recorded by a counter is equal to the default value.

15. The logistics method as claimed in claim 13, wherein the method further comprises:
receiving a second signal, and calculating a fifth optimal path for the logistic vehicle from the current position to the next production equipment which transmitted the second signal when the number recorded by the counter is smaller than the default value.
